(19) United States
(12) Patent Application Publication
(10) Pub. No.: US 2015/0193447 A1
(43) Pub. Date: Jul. 9, 2015

(54) SYNTHETIC LOCAL TYPE-AHEAD SUGGESTIONS FOR SEARCH

(71) Applicant: Microsoft Corporation, Redmond, WA (US)

(72) Inventors: Daniel Voinea, London (GB); Mariusz Kukawski, London (GB); Paul Baecke, London (GB); Andras Csehi, London (GB); Darrin Eide, Bellevue, WA (US)

(73) Assignee: Microsoft Corporation, Redmond, WA (US)

(21) Appl. No.: 14/147,107

(22) Filed: Jan. 3, 2014

(51) Int. Cl. G06F 17/30

(52) U.S. Cl. CPC G06F 17/3064; G06F 17/30867

(57) ABSTRACT

Architecture that generates local intent suggestions as completion suggestions (auto-suggest solutions) for an incomplete (or partially-entered) search query. The local intent suggestions are “synthetic” in that these suggestions are derived based on the near or total absence of any prior query history. The local intent suggestions can be derived and presented without the typical web-based suggestions or with the web-based suggestions. The web-based suggestions are blended (e.g., placed above, under, or mixed in with) with the local intent suggestions and displayed to the user. Web interfaces include, but are not limited to a full page display interface (e.g., that includes a full page map, pin points with images, sub-intents, title and description), and/or a right pane (sub-pane) auto-suggest interface with mini-map pinpoints, sub-intents, and disambiguation tiles, for example.

### BACKGROUND

Throughout the search industry the type-ahead suggestions (also referred to as auto-complete) are based on frequent past queries. This poses a difficult challenge in the local intent domain, since the local intent domain comprises infrequently or a total absence of observed tail queries, and moreover, may need to be disambiguated from other infrequently or non-observed queries.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture generates local intent suggestions as completion suggestions (auto-suggest solutions) as part of query entry (whether partially-entered or completely entered). The local intent suggestions are “synthetic” in that these suggestions are derived based on the near or total absence of any prior query history. The local intent suggestions can be derived and presented without the typical web-based suggestions or with the web-based suggestions. The blending of the synthetically-generated local suggestions with statistical web-based suggestions enables the storage and retrieval of relevant tail local intent suggestions and presentation thereof to the user.

A query (the characters the user has typed into the search box, e.g., incomplete, and also referred to as a prefix) is sent to an “auto-suggest” stack. The split between synthetic processing and web-based processing occurs at the beginning of the stack, and the paths merge just before ranking. The regular web suggestions are retrieved from data structures that store “seen before” queries (i.e., queries that have been input before by users and to which results are related; also referred to as history-based queries). These “seen before” queries have an historical aspect, whereas the synthetic suggestions are generated based on a near or complete lack of history for the given query.

As part of the synthetic (or non-history) query processing, the query is passed to a non-history search framework (for semantic pre-processing) where the appropriate generators (sub-workflows) are selected. Semantic pre-processing can be global (selecting the appropriate synthetic generator) and specialized (for a sub-workflow, such as local).

The non-history search framework can interface to a set of query/intent classifiers (e.g., machine learned, rule based, etc.) via which to classify the prefix. For example, if the prefix is classified as local, the prefix is sent to a geospatial sub-workflow, but not necessarily to other semantic processors. A given classifier computes a score that provides an indication as to if the entered (e.g., typed, voiced, etc.) query has potential local intent. The score can optionally be used for other purposes, as well.

Each sub-workflow (e.g., local) can have its own pre-processor which adds more data to the prefix or creates multiple variants of the same prefix. For local synthetic suggestions, the query is processed by the geo-spatial sub-workflow (which includes the geo-spatial pre-processor and a constraint index). Here, the query can be bundled with additional user spatial information, as provided by the “constraint index”.

The constraint index comprises components that encode local intent grammars and a local entity spatial index optimized for query completion. For example, the constraint index comprises multiple machines that operate on local physical entities, local feed businesses, and roads. The constraint index operates to provide both prefix completion tries for semantic completion and a spatial index that enables efficient geographical coordinate-restricted (e.g., latitude/longitude) lookups. The top local synthetic suggestions are output from the geo-spatial sub-workflow (a geo-spatial component), which comprises the constraint processing.

As obtained as part of constraint processing, the most probable partial query interpretations are analyzed, respecting both explicit and implicit features. Explicit user locations and geographically defined bounding boxes are retrieved from geographical sources of information such as reverse IP address, Wi-Fi location, cell tower, map rectangle view, geographical coordinates (e.g., from global positioning system (GPS)), and self-declared user settings, for example.

The top local synthetic suggestions obtained from the constraint processing are sent to a machine-learning based ranker (as part of the geo-spatial workflow) that further refines the order of the local (intent) suggestions based on static and dynamic query/entity features and user features. Example features include, but are not limited to, the total number of past observed and retrieved queries for the partially-input query, the total number of local dynamically-generated local suggestions for the partially-input query, the user's device type, the user's location, the length of the partially-input query, the distance between the most probable local suggestion and the user's location, the static rank of the top local entity retrieved for the partially-input query, the semantic interpretation probability, etc. Supervised learning can also be used.

The output(s) of the sub-workflow(s) are then aggregated and sent to a merger that performs merging (e.g., placed above, under, or mixed in with) and deduplication of web and semantic results. Feature extraction and final ranking are performed for presentation to the web-based and/or synthetic suggestions.

In an alternative embodiment, after concurrently checking for/retrieving regular web-based suggestions for the query and/or synthetic local intent suggestions for the query, a classifier score can be included in the features that provides an indication as to if the entered (e.g., typed, voiced, etc.) query has potential local intent based on dynamic and static features. A final ranker (e.g., a ranker component) can then perform the blending (merging) by scoring both the synthetic and web suggestions, and sorting. The web-based suggestions are blended (e.g., placed above, under, or mixed in with) with the local intent suggestions and displayed to the user.

Web interfaces include, but are not limited to a full page display interface (e.g., that includes a full page map, pin points with images, sub-intents, title and description), and/or a right pane (sub-pane) auto-suggest interface with mini-map pinpoints, sub-intents, and disambiguation tiles, for example.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system for synthetic local type-ahead suggestions for search in accordance with the disclosed architecture.

FIG. 2 illustrates an alternative system for synthetic local type-ahead suggestions for search in accordance with the disclosed architecture.

FIG. 3 illustrates a flow diagram of synthetic local type-ahead suggestions for search.

FIG. 4 illustrates a method in accordance with the disclosed architecture.

FIG. 5 illustrates an alternative method in accordance with the disclosed architecture.

FIG. 6 illustrates an exemplary search user interface of synthetic local type-ahead suggestions for search.

FIG. 7 illustrates a user interface that blends local intent suggestions and web-based suggestions based on an address query.

FIG. 8 illustrates a user interface that blends local intent suggestions and web-based suggestions based on a point-of-interest query.

FIG. 9 illustrates a user interface that blends local intent suggestions and web-based suggestions based on a local “what-where” query.

FIG. 10 illustrates a user interface that blends local intent suggestions and web-based suggestions based on a local “what” query.

FIG. 11 illustrates a user interface that blends local intent suggestions and web-based suggestions based on a local “what-where” query with “what” expansion in a full page rich interface.

FIG. 12 illustrates a user interface that blends local intent suggestions and web-based suggestions based on a local “what-where” query.

FIG. 13 illustrates a user interface that blends local intent suggestions and web-based suggestions based on a local “what-where” query.

FIG. 14 illustrates a user interface that presents a right pane preview for local “what-where” query.

FIG. 15 illustrates a user interface that presents a right pane preview for local “what” query and disambiguation.

FIG. 16 illustrates a block diagram of a computing system that executes synthetic local type-ahead suggestions for search in accordance with the disclosed architecture.

### DETAILED DESCRIPTION

The disclosed architecture enables the “synthetic” (suggestions derivation based on the near or total absence of any previous related local query activity) generation of local type-ahead (also referred to as auto-complete or auto-suggest) suggestions based on grammars and entity indices. A local query embodies properties such as: “what” and “where” (e.g., “HSBC (what) Victoria street (where)”, “plumbers (what) in London (where)”, etc.); what “starbucks” or where (“26 paul gardens Croydon”); and/or, category. The synthetic suggestions can be blended with existing web-based suggestions. Additionally, the architecture also provides a web display and disambiguation user interface for content-rich local intent suggestions.

The query (the characters the user has already typed in the search box) is sent to an “auto-suggest” stack where regular web suggestions are retrieved from data structures that store “seen before” (historical) queries (queries that have been input before by users and to which results are related). These “seen before” queries have an historical aspect, whereas the synthetic suggestions are generated based on a complete lack of history for the given query.

The query is bundled with additional user spatial information, and is additionally processed using grammar-based type-ahead prediction component. The constraint index is a combination of finite state transducers (e.g., components that encode local intent grammars) and a local entity spatial index optimized for query completion (auto-suggestion).

The most probable query interpretations are explored, respecting both explicit (e.g., “region search”, market language, user location, etc.) and implicit (e.g., “New York implies Sweden is not valid for New York S”, etc.) features. Explicit user locations and bounding boxes (defined geographical areas) are retrieved from reverse IP address, Wi-Fi, cell tower, map rectangle view, geographical coordinates (e.g., from global positioning system (GPS)) and self-declared user settings.

The top synthetic suggestions are sent to a machine-learning based ranker that further refines the order of the local (intent) suggestions based on static and dynamic query/entity features and user features. After retrieving both regular web suggestions for the query and local synthetic suggestions for the query, a classifier (e.g., machine learned, rule based, etc.) computes a score that provides indication as to if the entered (e.g., typed, voiced, etc.) query has potential local intent (based on dynamic and static features).

Example features include, but are not limited to, the total number of past observed and retrieved queries for the partially-input query, the total number of local dynamically-generated local suggestions for the partially-input query, the user's device type, the user's location, the length of the partially-input query, the distance between the most probable local suggestion and the user's location, the static rank of the top local entity retrieved for the partially-input query, the semantic interpretation probability, etc. Supervised learning can also be used.

Based on the classifier score the regular web suggestions are blended (e.g., placed above, under, or mixed in with) with local suggestions and displayed to the user. Web interfaces include, but are not limited to a full page display interface (e.g., that includes a full page map, pin points with images, sub-intents, title and description), and/or a right pane (sub-pane) auto-suggest interface with mini-map pinpoints, sub-intents, and disambiguation tiles, for example.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

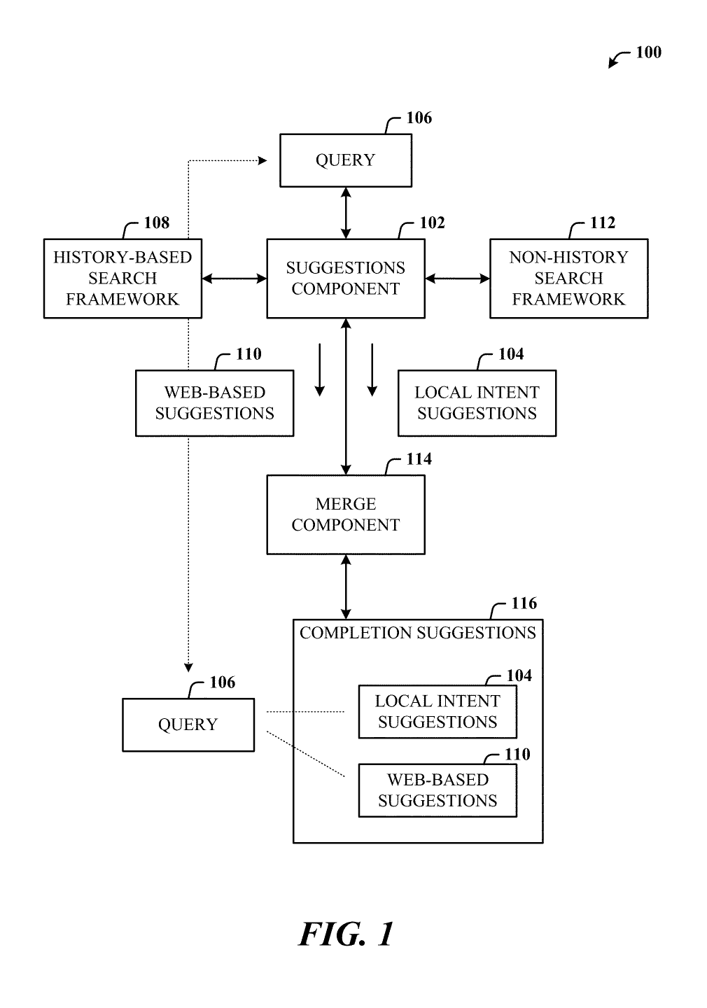

FIG. 1 illustrates a system 100 for synthetic local type-ahead suggestions for search in accordance with the disclosed architecture. The system 100 can include a suggestions component 102 configured to return local intent suggestions 104 for a query 106 based in part on the absence or near absence (minimal instances) of previous queries (previously-processed or history-based) related to the query 106. In other words, in one embodiment, the local intent suggestions 104 are generated neither from history-based query results computed to be related to the query nor from any local queries that have been previously processed—the local intent suggestions 104 are generated without any prior query history (“synthetically” generated).

Accordingly, the suggestions component 102 interfaces to a history-based search framework 108 (e.g., web-based) to obtain web-based suggestions 110 and a non-history (or minimal history) search framework 112 to obtain the synthetically-generated local intent suggestions 104. A merge component 114 is configured to merge (or blend) the local intent suggestions 104 and web-based suggestions 110 for presentation as completion suggestions 116 to the query 106 (shown proximate the completion suggestions 116 as well).

The suggestions component 102 processes user spatial information to derive the local intent suggestions 104. The spatial information can be based on local intent grammars and a local entity spatial index (the geographical parameters associated with a given entity such as a person, business, event, point of interest, etc.). The web-based suggestions 110, where present, are presented as combined with the local intent suggestions 104 in a full-page view of auto-suggestions or a sub-pane of auto-suggestions that complete the query. This is described hereinbelow. The local intent suggestions 104 relate to properties of at least one of what, where, or category. The “what” property is the specific entity, the “where” property is the location information of the entity, and the “category” property is a general category of entity, such as restaurant, business, venue, etc.

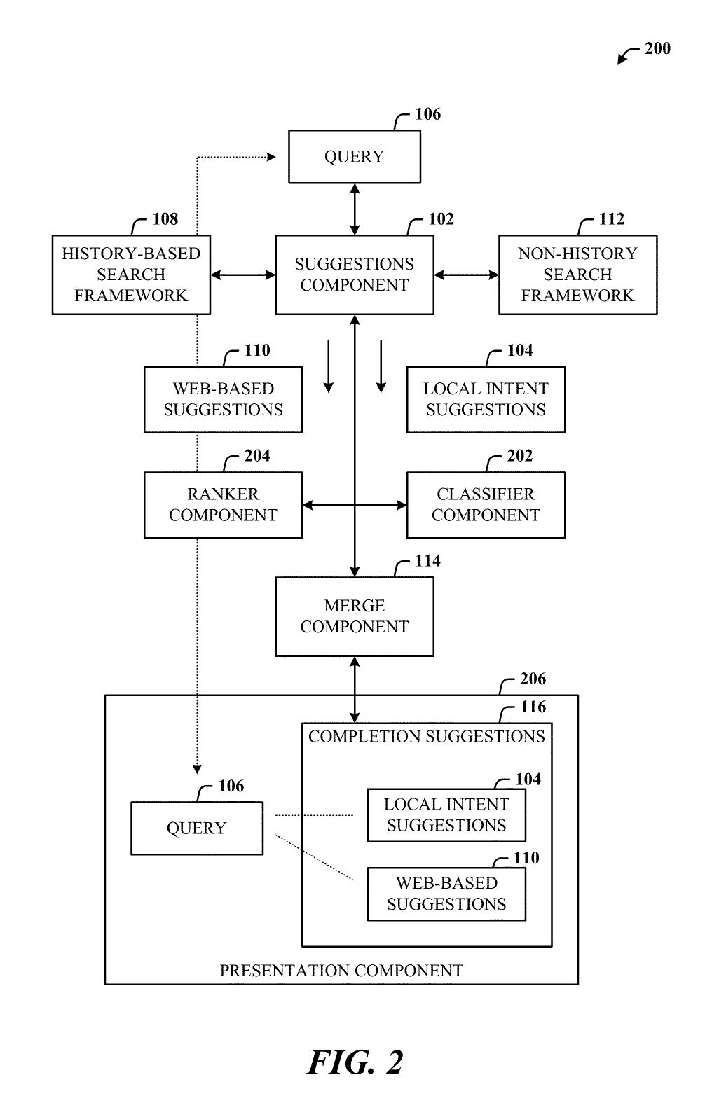

FIG. 2 illustrates an alternative system 200 for synthetic local type-ahead suggestions for search in accordance with the disclosed architecture. The system 200 comprises the system 100 of FIG. 1 as well as additional components. For example, the system 200 comprises a classifier component 202 configured to generate a classifier score that corresponds to potential local intent for the query 106. After retrieving the web-based suggestions 110 (if obtained) for the query 106, and the local intent suggestions 104 for the query 106, the classifier component (e.g., machine learned, rule based, etc.) computes a score based on local semantics that provide an indication as to if the entered (e.g., typed, voiced, etc.) query 106 has potential local intent (based on dynamic and static features) for which to derive the local intent suggestions 104. The web-based suggestions 110 are presented under, above, or with the local intent suggestions 104 based on the classifier score.

The system 200 can further comprise a ranker component 204 configured to order the local intent suggestions 104 and, if obtained, the web-based suggestions 110 based on query/entity features and user features. The system 200 can further comprise a presentation component 206 (e.g., a browser application) configured to present and visually differentiate the local intent suggestions 104 from the web-based suggestions 110 as auto-complete suggestions to the query 106 in a user interface.

It is to be understood that in the disclosed architecture, certain components may be rearranged, combined, omitted, and additional components may be included. Additionally, in some embodiments, all or some of the components are present on the client, while in other embodiments some components may reside on a server or are provided by a local or remove service.

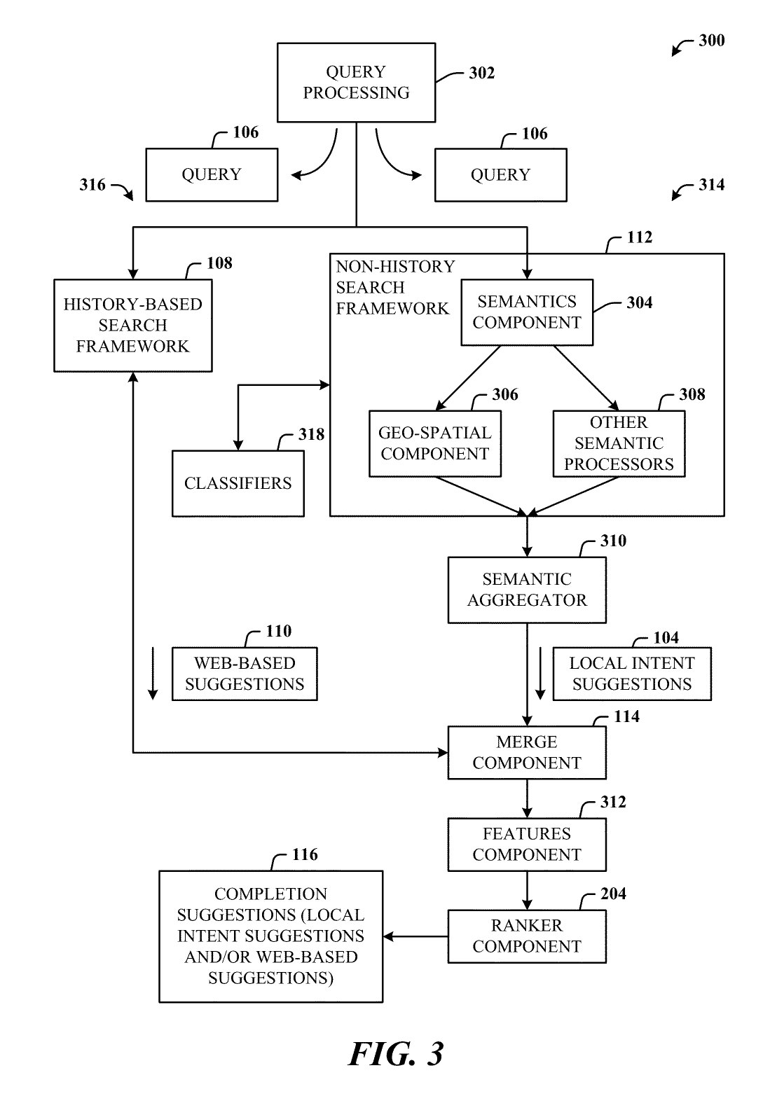

FIG. 3 illustrates a flow diagram 300 of synthetic local type-ahead suggestions for search. Query processing 302 begins by passing the query 106 to the history-based search framework 108 and the non-history search framework 112. It is to be understood that the “non-history” and “absence of” qualifiers are intended to include not only the total absence of history, but also minimal history to such extent that any amount of history that may exist is insufficient or inadequate for generating the local intent suggestions.

The output of the history-based search framework 108 is the web-based suggestions 110. The non-history search framework 112 is a semantics processing branch via a semantics component 304. The semantics component 304 performs semantic interpretation of the query for top synthetic suggestions. Additionally, the non-history search framework 112 provides geo-spatial processing and other semantic processors.

A geo-spatial component 306 computes the user geographical location using any means available, such as from explicit user location information and bounding boxes (defined geographical areas) obtained from reverse IP address, Wi-Fi, cell tower, map rectangle view, geographical coordinates (e.g., from global positioning system (GPS)) and self-declared user settings, for example. Other semantic processors 308 can be employed to perform disambiguation for a given area, for example.

Output of the geo-spatial component 306 and the other semantic processors 308 (also the output of the non-history search framework 112) is sent to a semantic aggregator 310, which outputs the local intent suggestions 104 to the merge component 114. The merge component 114 merges the web-based suggestions 110 and the local intent suggestions 104.

This merged set is then processed by a features component 312 to further refine the merged set of suggestions. Features include, but are not limited to, the total number of past observed and retrieved queries for the partially-input query, the total number of local dynamically-generated local suggestions for the partially-input query, the user's device type, the user's location, the length of the partially-input query, the distance between the most probable local suggestion and the user's location, the static rank of the top local entity retrieved for the partially-input query, the semantic interpretation probability, etc. The ranker component 204 is configured to order the local intent suggestions 104 and, if obtained, the web-based suggestions 110, based on query/entity features and user features and then to output the query completion suggestions 116.

Put another way, the query 106 (the characters the user has typed into the search box, e.g., incomplete, and also referred to as a prefix) is sent to an “auto-suggest” stack. The split between synthetic processing 314 and web-based processing 316 occurs at the beginning of the stack, and the paths merge just before ranking (by the ranking component 204). The regular web suggestions are retrieved from data structures that store “seen before” queries (i.e., queries that have been input before by users and to which results are related; also referred to as history-based queries). These “seen before” queries have an historical aspect, whereas the synthetic suggestions are generated based on a near or complete lack of history for the given query.

As part of the synthetic (or non-history) query processing, the query 106 is passed to the non-history search framework 112 (for semantic pre-processing) where the appropriate generators (sub-workflows) are selected. Semantic pre-processing can be global (selecting the appropriate synthetic generator) and specialized (for a sub-workflow, such as local).

The non-history search framework 112 can interface to a set of query/intent classifiers 318 (e.g., machine learned, rule based, etc.) via which to classify the prefix. For example, if the prefix is classified as local, the prefix is sent to a geospatial sub-workflow (the geo-spatial component 306), but not necessarily to the other semantic processors 308. A given classifier (of the classifiers 318) computes a score that provides an indication as to if the entered (e.g., typed, voiced, etc.) query 106 has potential local intent. The score can optionally be used for other purposes, as well.

Each sub-workflow (e.g., local), such as the geo-spatial component 306, can have its own pre-processor, which adds more data to the prefix or creates multiple variants of the same prefix. For local synthetic suggestions, the query 106 is processed by the geo-spatial sub-workflow (which includes the geo-spatial pre-processor and a constraint index). Here, the query 106 can be bundled with additional user spatial information, as provided by the constraint index.

The constraint index (of the geo-spatial component 306) further comprises components that encode local intent grammars and a local entity spatial index optimized for query completion. For example, the constraint index comprises multiple machines that operate on local physical entities, local feed businesses, and roads. The constraint index operates to provide both prefix completion tries for semantic completion and a spatial index that enables efficient geographical coordinate-restricted (e.g., latitude/longitude) lookups. The top local synthetic suggestions are output from the geo-spatial sub-workflow (the geo-spatial component 306), which comprises the constraint processing.

As obtained as part of constraint processing, the most probable partial query interpretations are then analyzed, respecting both explicit and implicit features. Explicit user locations and geographically defined bounding boxes are retrieved from geographical sources of information such as reverse IP address, Wi-Fi location, cell tower, map rectangle view, geographical coordinates (e.g., from global positioning system (GPS)), and self-declared user settings, for example.

The top local synthetic suggestions obtained from the constraint processing (of the geo-spatial component 306) are sent to a machine-learning based ranker (as part of the geo-spatial component 306) that further refines the order of the local (intent) suggestions based on static and dynamic query/entity features and user features. Example features include, but are not limited to, the total number of past observed and retrieved queries for the partially-input query, the total number of local dynamically-generated local suggestions for the partially-input query, the user's device type, the user's location, the length of the partially-input query, the distance between the most probable local suggestion and the user's location, the static rank of the top local entity retrieved for the partially-input query, the semantic interpretation probability, etc. Supervised learning can also be used.

The output(s) of the sub-workflow(s) (the geo-spatial component 306 and other semantic processors 308) are then aggregated (by the semantic aggregator 310) and sent to a merger (merge component 114) that performs merging (e.g., placed above, under, or mixed in with) and deduplication of web and semantic results. Feature extraction and final ranking are performed for presentation to the web-based and/or synthetic suggestions.

In an alternative embodiment, after concurrently checking for/retrieving regular web-based suggestions for the query 106 and/or synthetic local intent suggestions for the query 106, a classifier score can be included in the features that provides an indication as to if the entered (e.g., typed, voiced, etc.) query 106 has potential local intent, based on dynamic and static features. A final ranker (e.g., the ranker component 204) can then perform the blending (merging) by scoring both the synthetic and web suggestions, and sorting. The web-based suggestions are blended (e.g., placed above, under, or mixed in with) with the local intent suggestions and displayed to the user.

Although not shown, the systems (100 and 200) can also employ a privacy component that enables the user to opt in or out of exposing personal information such as location information, and information associated with the features, for example.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

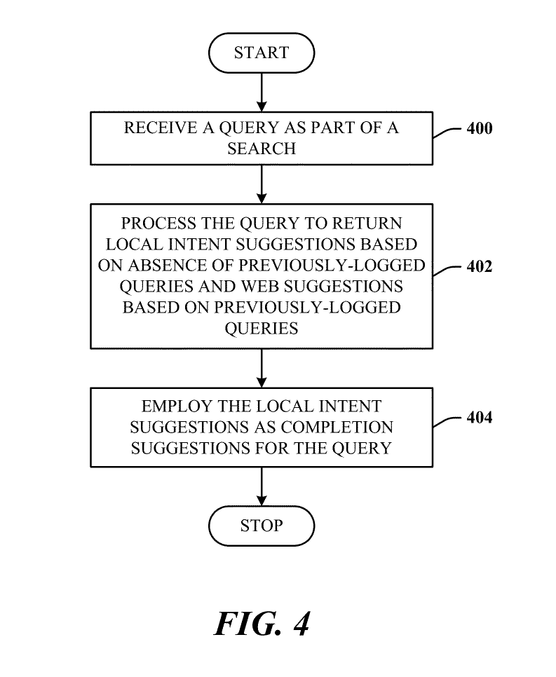

FIG. 4 illustrates a method in accordance with the disclosed architecture. At 400, a query is received as part of a search. At 402, the query is processed to return local suggestions based on an absence of previously-logged queries and web suggestions based on previously-logged queries. At 404, the local intent suggestions are employed as completion suggestions for the query.

The method can further comprise merging the local intent suggestions and the web suggestions for presentation. The method can further comprise ranking the local intent suggestions and the web suggestions for presentation. The method can further comprise visually differentiating the local suggestions from the web suggestions in a user interface. The method can further comprise presenting the web-based suggestions under, above, or with the local intent suggestions based on a classifier score.

The method can further comprise applying a classifier to the query to compute local intent based on dynamic and static features. The method can further comprise interpreting the query to compute top semantic interpretations. The method can further comprise deriving the local intent suggestions based on a local intent grammar and a local entity index.

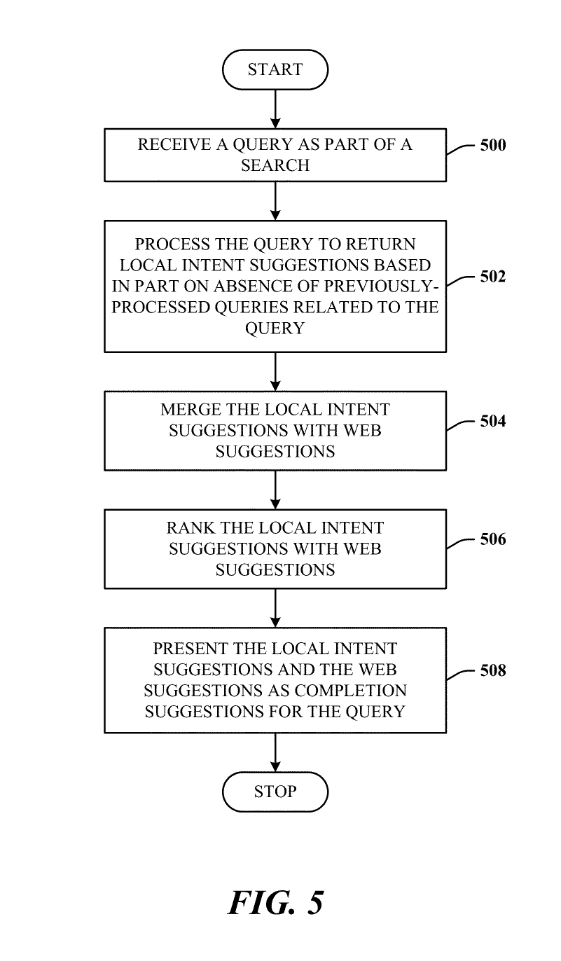

FIG. 5 illustrates an alternative method in accordance with the disclosed architecture. At 500, a query is received as part of a search. At 502, the query is processed to return local intent suggestions based in part on absence of previously-processed queries related to the query. At 504, the local intent suggestions are merged with web suggestions. At 506, the local intent suggestions are ranked with web suggestions. At 508, the local intent suggestions and the web suggestions are presented as completion suggestions for the query.

The method can be embodied on computer-readable storage medium comprising computer-executable instructions that when executed by a microprocessor, which instructions cause the microprocessor to perform acts of the method. The acts of the method can further comprise visually differentiating the local suggestions from the web suggestions in a user interface, and deriving the local suggestions based on a local intent grammar and a local entity index.

The acts of the method can further comprise applying a classifier to the query to compute local intent based on dynamic and static features. The acts of the method can further comprise obtaining and processing user spatial information to derive the local intent suggestions, the spatial information based on local intent grammars and a local entity spatial index.

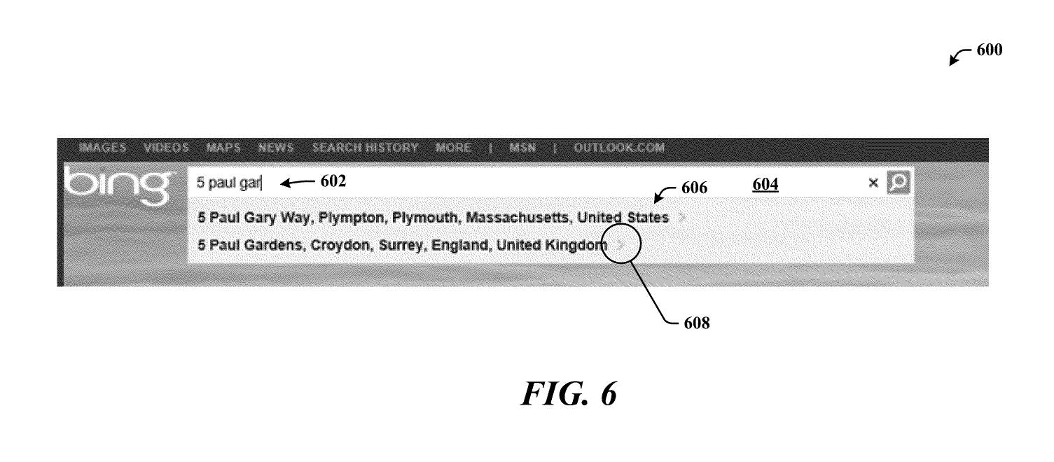

FIG. 6 illustrates an exemplary search user interface 600 of synthetic local type-ahead suggestions for search. Here, the UI 600 presents dynamically generated local intent suggestions of local intent, only. A query 602 (being entered into a query box 604) is dynamically processed as a user enters characters, and the local intent suggestions 606 are automatically generated and presented underneath the query box 604 as completion suggestions (here, only local intent suggestions) to the query 602.

Note that the dynamic aspect is exhibited for each character entered as part of the query 602, as the completion suggestions may change for each character entered. This presentation can be a full page display of the user interface 600. Note that in this particular implementation, the local intent suggestions 606 are each identified by graphical emphasis 608, such as a chevron icon (indicated inside the circle tag).

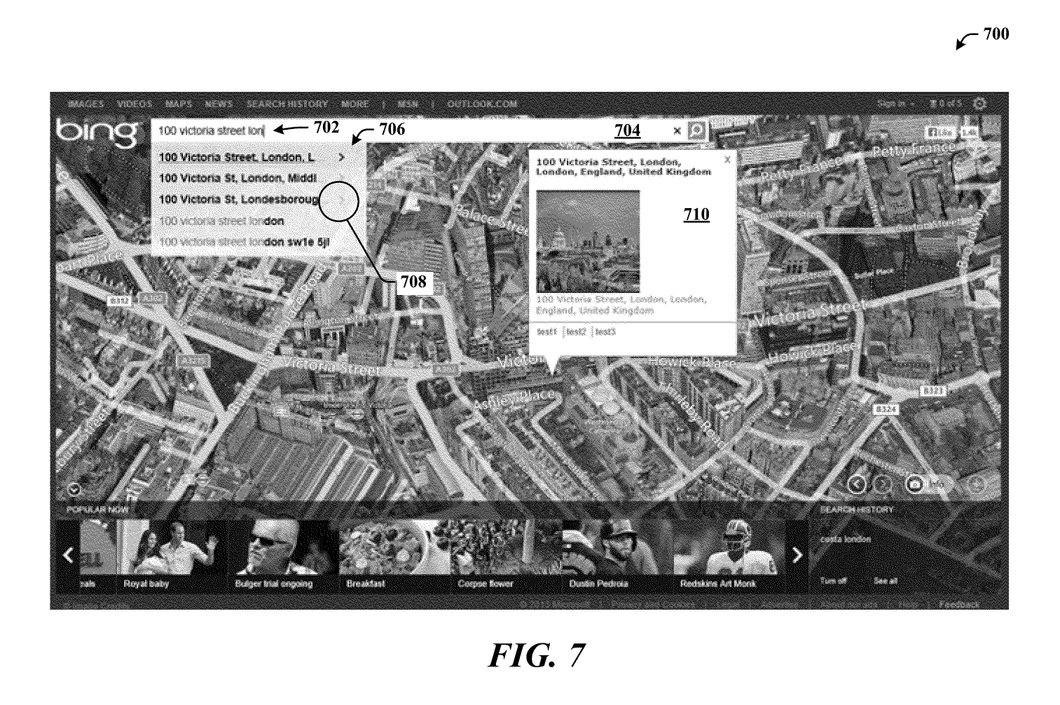

FIG. 7 illustrates a user interface 700 that blends local intent suggestions and web-based suggestions based on an address query. A query 702 (being entered into a query box 704) is dynamically processed as a user enters characters, and the local intent suggestions are automatically generated and presented underneath the query box 704 with web-based suggestions as completion suggestions 706 to the query 702. Note that the dynamic aspect is exhibited for each character entered as part of the query 702, as the completion suggestions 706 may change for each character entered. Here, the web-based suggestions are presented below the local intent suggestions.

The UI 700 is a full page rich display interface that shows details such as street address. Here, the UI 700 presents dynamically generated local intent suggestions (identified with the chevron icons 708), and the web-based suggestions (no associated chevron icon) listed below the local intent suggestions. Note also that the top-ranked local intent suggestion (“100 Victoria Street, London, L”) has an associated bolded chevron, indicating a related pinpoint box 710, having an image, sub-intents, title, descriptions, etc.

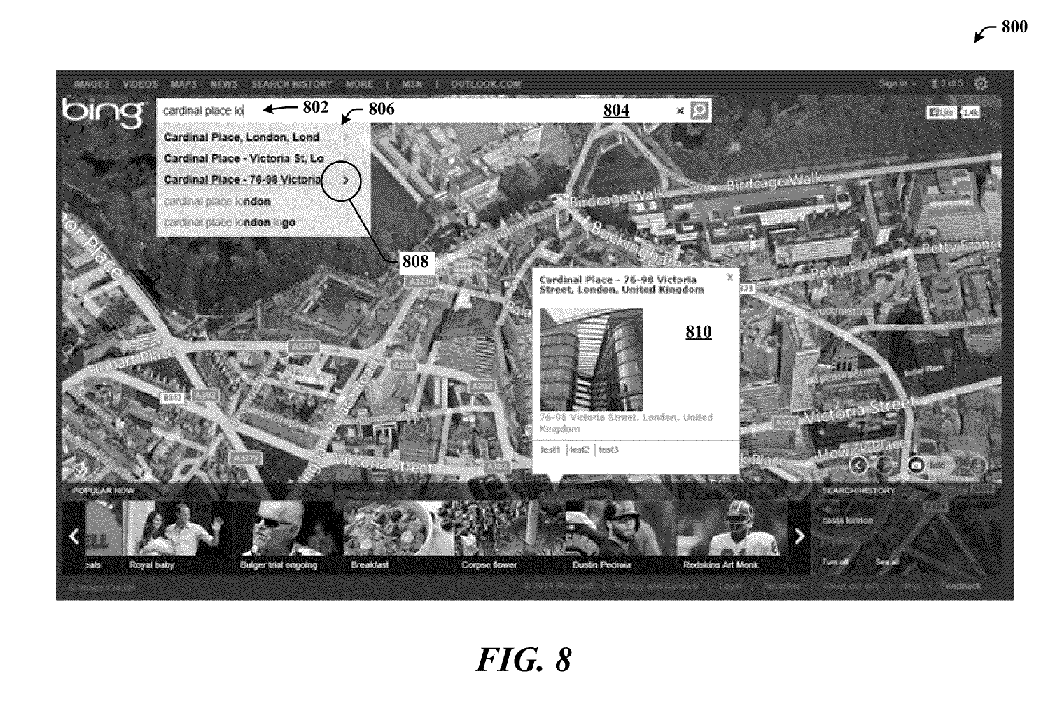

FIG. 8 illustrates a user interface 800 that blends local intent suggestions and web-based suggestions based on a point-of-interest query. A query 802 (being entered into a query box 804) is dynamically processed as a user enters characters, and the local intent suggestions are automatically generated and presented underneath the query box 804 with web-based suggestions as completion suggestions 806 to the query 802. Here, the web-based suggestions are presented below the local intent suggestions. Note that the dynamic aspect is exhibited for each character entered as part of the query 802, as the completion suggestions 706 may change for each character entered.

The UI 800 is a full page rich display interface that shows details for points of interest. Here, the UI 800 presents dynamically generated local intent suggestions (identified with the chevron icons 808), and the web-based suggestions (no associated chevron icon) listed below the local intent suggestions. Note also that the one ranked local intent suggestion (“Cardinal Plaza—76-98 Victoria”) has an associated bolded chevron, indicating a related pinpoint box 810, having an image, sub-intents, title, descriptions, etc.

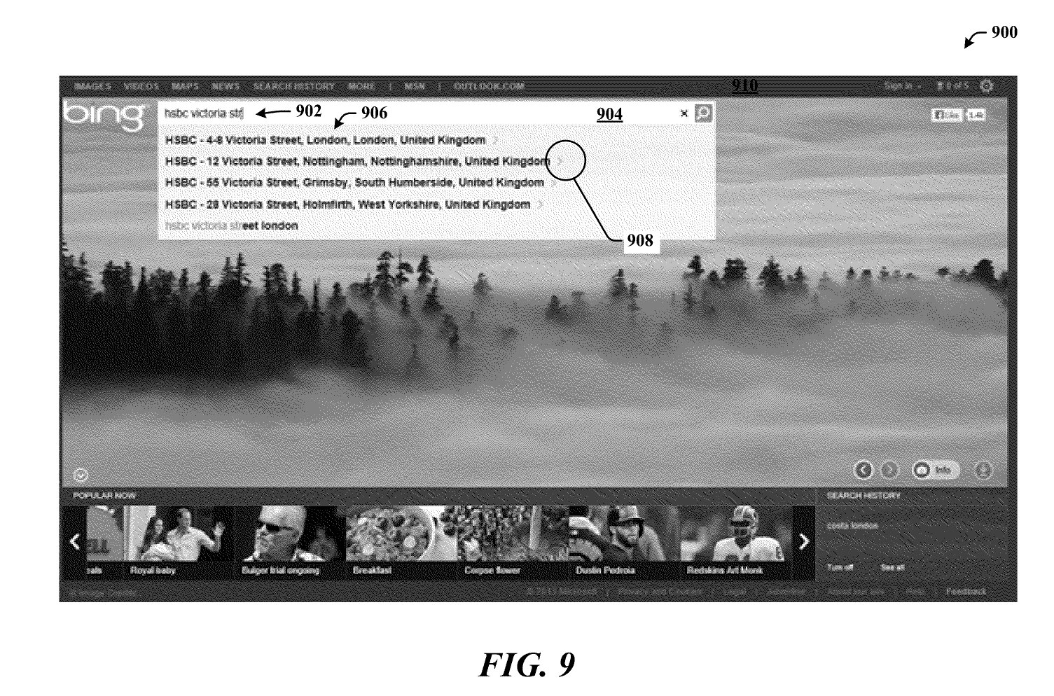

FIG. 9 illustrates a user interface 900 that blends local intent suggestions and web-based suggestions based on a local “what-where” query. A query 902 (in the process of being entered into a query box 904) is dynamically processed as a user enters characters, and the local intent suggestions are automatically generated and presented underneath the query box 904 with web-based suggestions as completion suggestions 906 to the query 902. Here, the web-based suggestion is presented below the local intent suggestions.

Note that the dynamic aspect is exhibited for each character entered as part of the query 902, as the completion suggestions 906 may change for each character entered. The UI 900 presents dynamically generated local intent suggestions (identified with the chevron icons 908), and the web-based suggestion (no associated chevron icon) listed below the local intent suggestions.

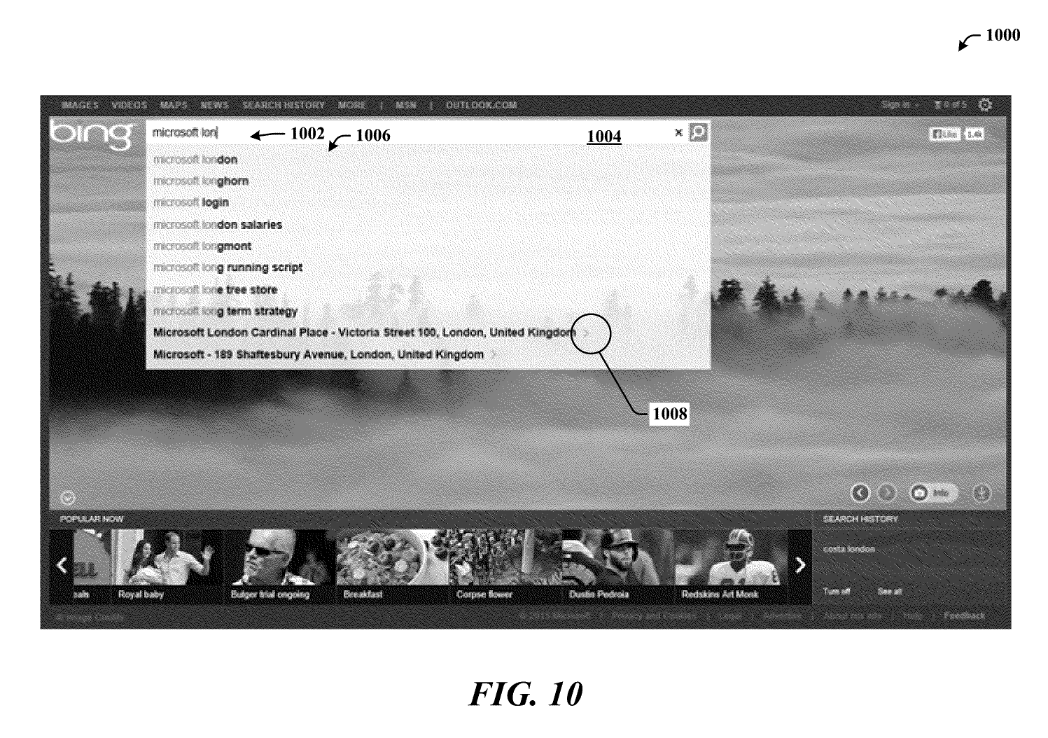

FIG. 10 illustrates a user interface 1000 that blends local intent suggestions and web-based suggestions based on a local “what” query. A query 1002 (in the process of being entered into a query box 1004) is dynamically processed as a user enters characters, and the local intent suggestions are automatically generated and presented underneath the query box 1004 with web-based suggestions as completion suggestions 1006 to the query 1002.

Note that the dynamic aspect is exhibited for each character entered as part of the query 1002, as the completion suggestions 1006 may change for each character entered. The UI 1000 presents dynamically generated local intent suggestions (identified with the chevron icons 1008), and the web-based suggestion (no associated chevron icon) listed above the local intent suggestions.

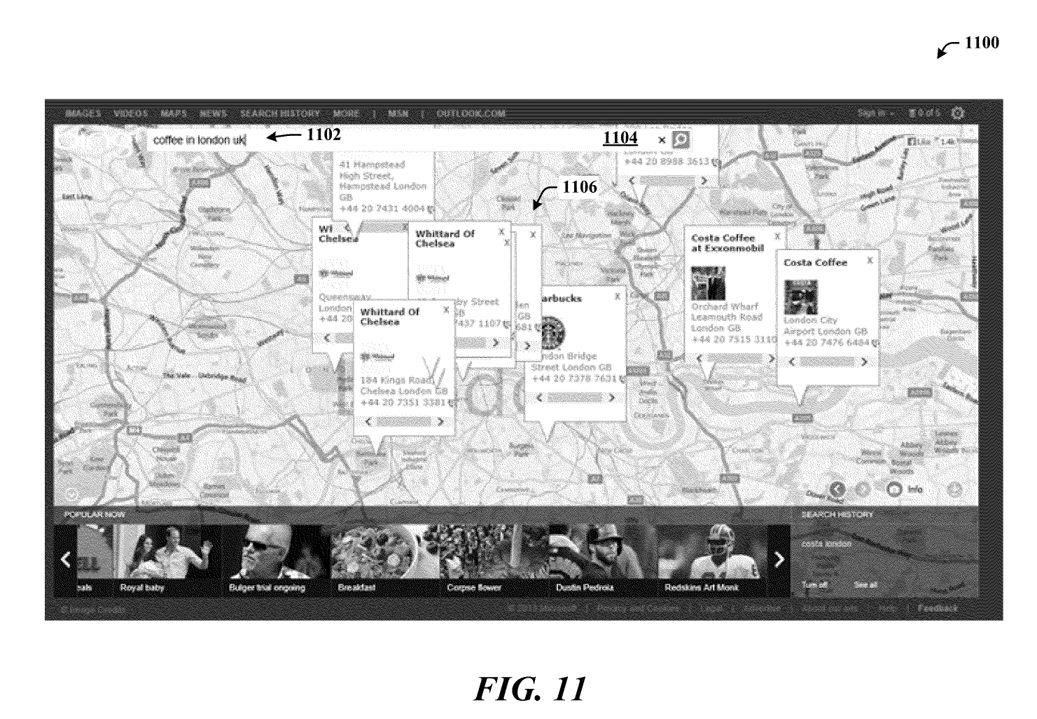

FIG. 11 illustrates a user interface 1100 that blends local intent suggestions and web-based suggestions based on a local “what-where” query with “what” expansion in a full page rich interface. A query 1102 (in the process of being entered into a query box 1104) is dynamically processed as a user enters characters, and the local intent suggestions are automatically generated and presented as fully expanded pin boxes 1106 overlayed on the background map. Note that the dynamic aspect is exhibited for each character entered as part of the query 1102, as the pin boxes may change for each character entered.

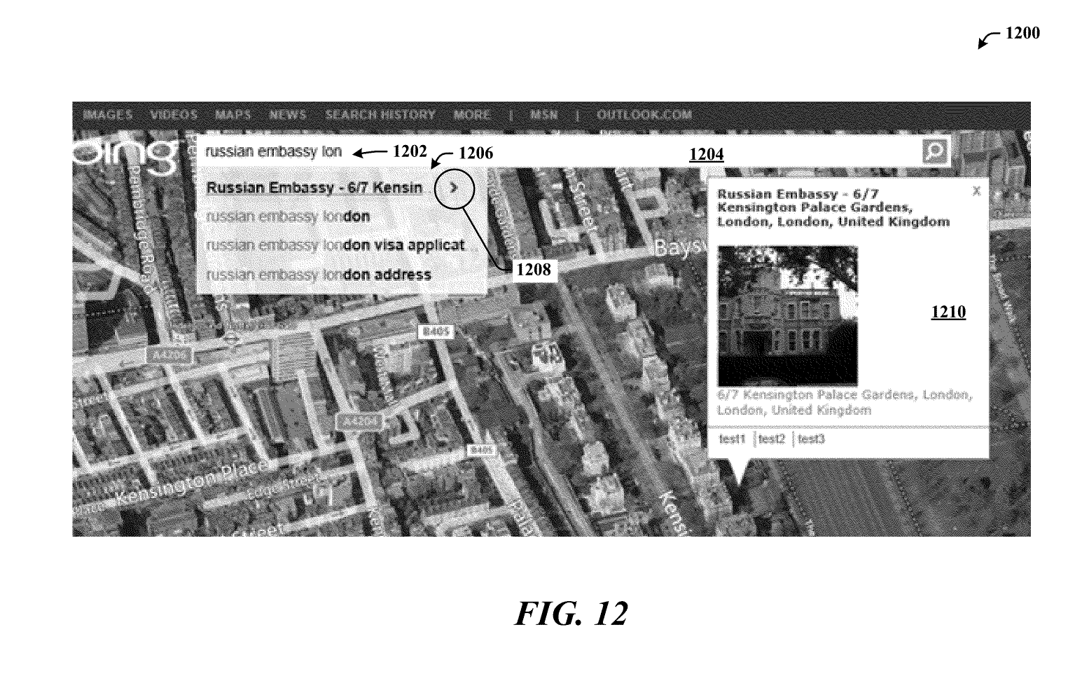

FIG. 12 illustrates a user interface 1200 that blends local intent suggestions and web-based suggestions based on a local “what-where” query. A query 1202 (in the process of being entered into a query box 1204) for an entity +location search is dynamically processed as a user enters the characters, and a local intent suggestion is automatically generated and presented underneath the query box 1204 with web-based suggestions as completion suggestions 1206 to the query 1202. Here, the web-based suggestions are presented below the local intent suggestion.

Note that the dynamic aspect is exhibited for each character entered as part of the query 1202, as the completion suggestions 1206 may change for each character entered. The UI 1200 presents dynamically generated local intent suggestions (identified with the chevron icon 1208), and the web-based suggestions (no associated chevron icon) listed below the local intent suggestion. Note also that the top-ranked local intent suggestion (“Russian Embassy—6/7 Kensin”) has an associated bolded chevron, indicating a related pinpoint box 1210, having an image, sub-intents, title, descriptions, etc.

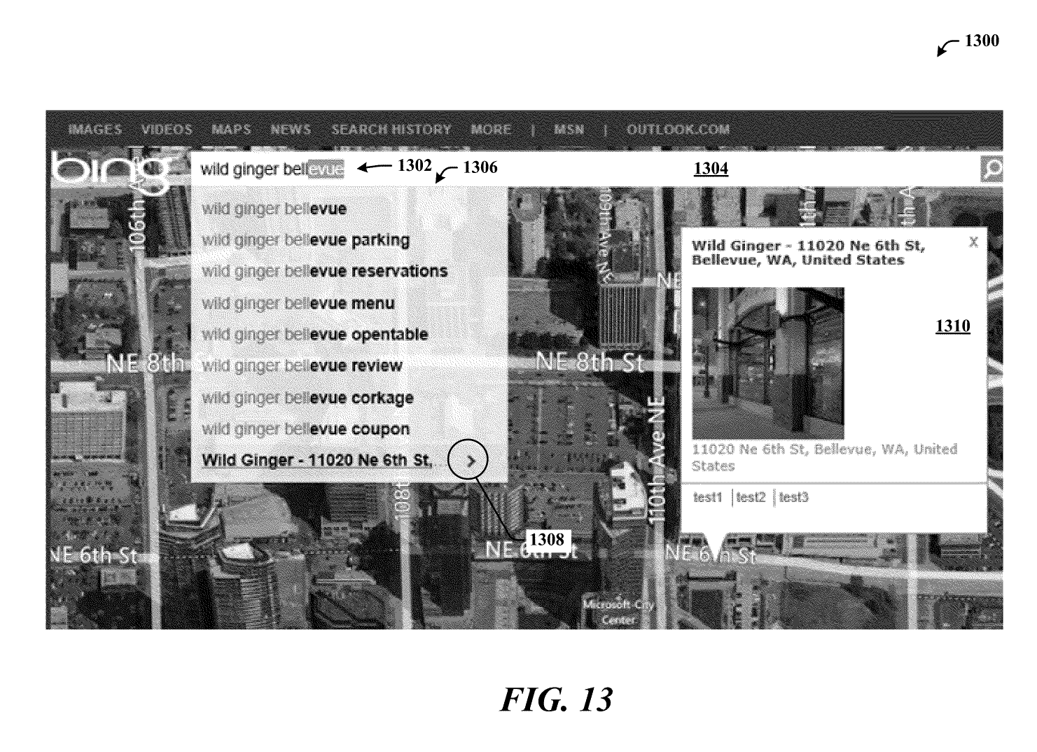

FIG. 13 illustrates a user interface 1300 that blends local intent suggestions and web-based suggestions based on a local “what-where” query. A query 1302 (in the process of being entered into a query box 1304) for an entity+location search is dynamically processed as a user enters the characters, and a local intent suggestion is automatically generated and presented underneath the query box 1304 with web-based suggestions as completion suggestions 1306 to the query 1302. Note that the dynamic aspect is exhibited for each character entered as part of the query 1302, as the completion suggestions 1306 may change for each character entered.

The UI 1300 presents dynamically generated local intent suggestions (identified with the chevron icon 1308), and the web-based suggestions (no associated chevron icon) listed above the local intent suggestion. Note also that the local intent suggestion (“Wild Ginger—11020 Ne 6^{th} St.”) has an associated bolded chevron, indicating a related pinpoint box 1310, having an image, sub-intents, title, descriptions, etc.

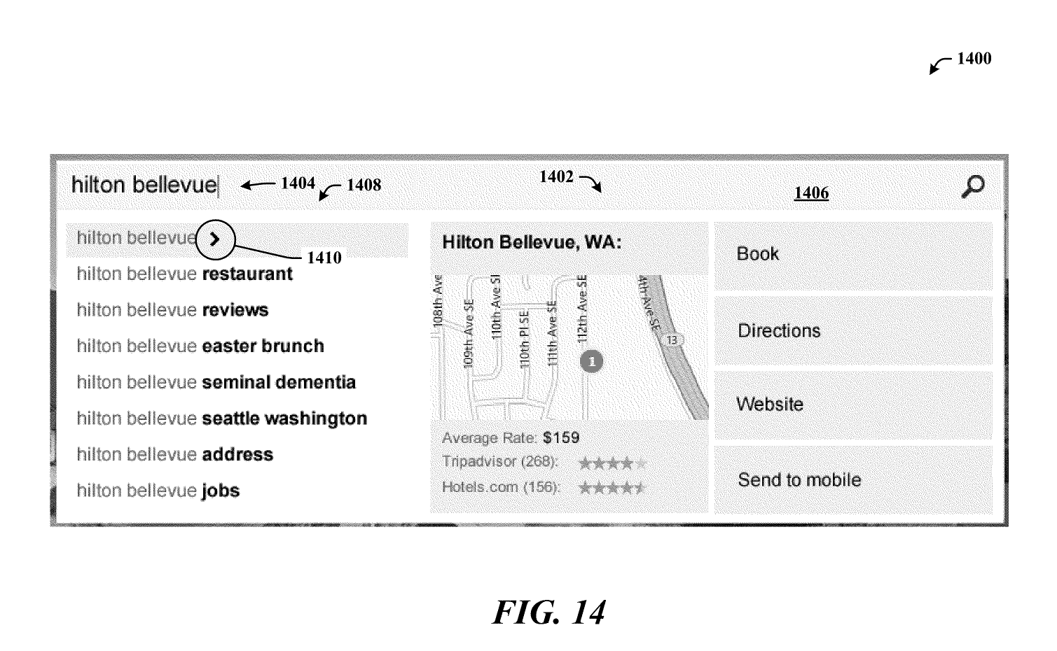

FIG. 14 illustrates a user interface 1400 that presents a right pane preview 1402 for local “what-where” query. A query 1404 (in the process of being entered into a query box 1406) for an entity+location search is dynamically processed as a user enters the characters, and a local intent suggestion is automatically generated and presented underneath the query box 1406 with web-based suggestions as completion suggestions 1408 to the query 1404. Note that the dynamic aspect is exhibited for each character entered as part of the query 1404, as the completion suggestions 1408 may change for each character entered.

The UI 1400 presents a dynamically generated local intent suggestion (identified with the chevron icon 1410), and the web-based suggestions (no associated chevron icon) listed below the local intent suggestion. Note also that the local intent suggestion (“hilton bellevue”) has an associated bolded chevron, indicating the related right-pane preview 1402, having a map image, sub-intents, title, descriptions, links to Books, Directions, a Website, Send to mobile, etc.

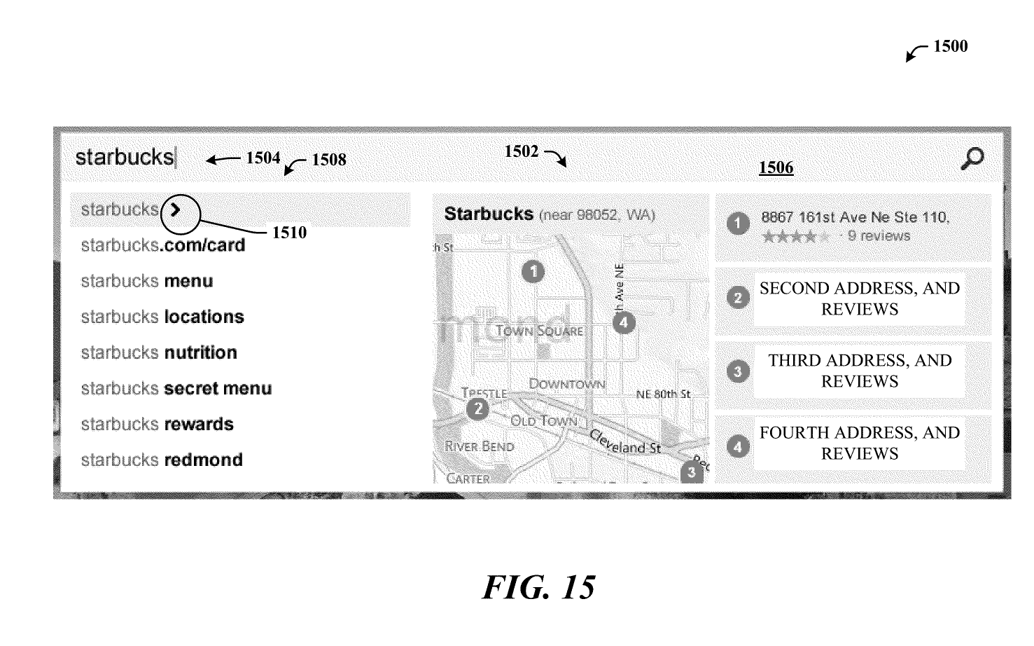

FIG. 15 illustrates a user interface 1500 that presents a right pane preview 1502 for local “what” query and disambiguation. A query 1504 (in the process of being entered into a query box 1506) for an entity search is dynamically processed as a user enters the characters, and a local intent suggestion is automatically generated and presented underneath the query box 1506 with web-based suggestions as completion suggestions 1508 to the query 1504. Note that the dynamic aspect is exhibited for each character entered as part of the query 1504, as the completion suggestions 1508 may change for each character entered.

The UI 1500 presents a dynamically generated local intent suggestion (identified with the chevron icon 1510), and the web-based suggestions (no associated chevron icon) listed below the local intent suggestion. Note also that the local intent suggestion (“starbucks”) has an associated bolded chevron, indicating the related right-pane preview 1502, having a map image annotated with different locations, and four different locations matching the mapped locations.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

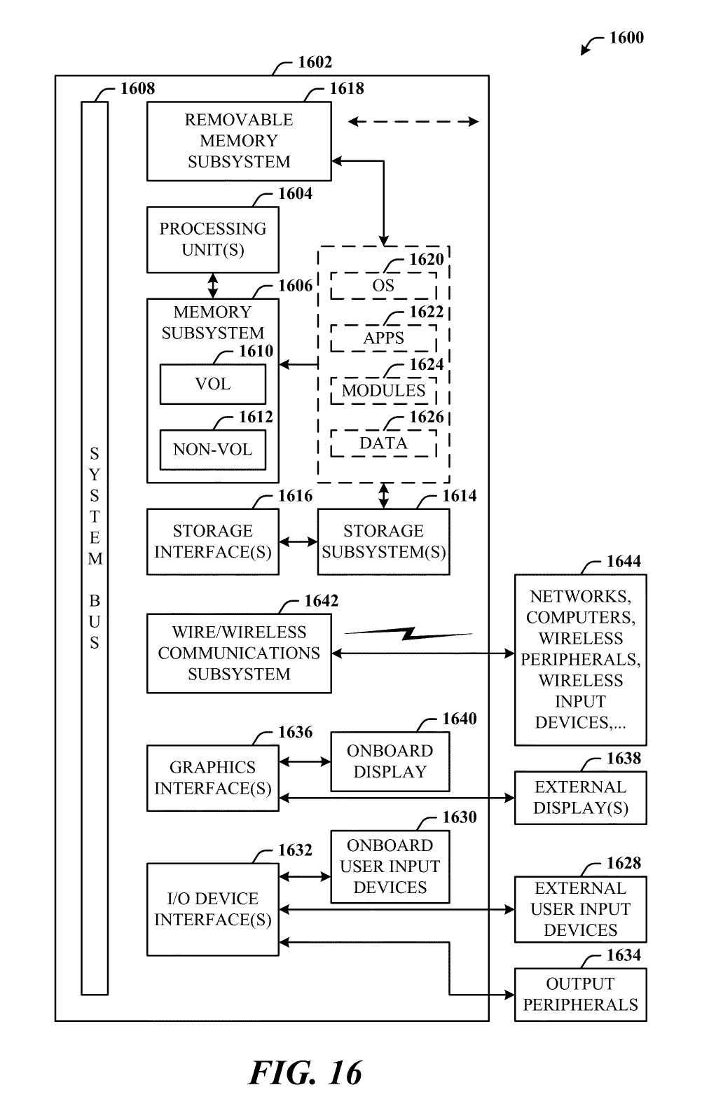

Referring now to FIG. 16, there is illustrated a block diagram of a computing system 1600 that executes synthetic local type-ahead suggestions for search in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 16 and the following description are intended to provide a brief, general description of the suitable computing system 1600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1600 for implementing various aspects includes the computer 1602 having microprocessing unit(s) 1604 (also referred to as microprocessor(s) and processor(s)), a computer-readable storage medium such as a system memory 1606 (computer readable storage medium/media also include magnetic disks, optical disks, solid state drives, external memory systems, and flash memory drives), and a system bus 1608. The microprocessing unit(s) 1604 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1602 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1606 can include computer-readable storage (physical storage) medium such as a volatile (VOL) memory 1610 (e.g., random access memory (RAM)) and a non-volatile memory (NON-VOL) 1612 (e.g., ROM, EPROM, EEPROM, etc.). A basic input/output system (BIOS) can be stored in the non-volatile memory 1612, and includes the basic routines that facilitate the communication of data and signals between components within the computer 1602, such as during startup. The volatile memory 1610 can also include a high-speed RAM such as static RAM for caching data.

The system bus 1608 provides an interface for system components including, but not limited to, the system memory 1606 to the microprocessing unit(s) 1604. The system bus 1608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1602 further includes machine readable storage subsystem(s) 1614 and storage interface(s) 1616 for interfacing the storage subsystem(s) 1614 to the system bus 1608 and other desired computer components and circuits. The storage subsystem(s) 1614 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 1616 can include interface technologies such as EIDE, ATA, SATA, and IEEE 1394, for example.

One or more programs and data can be stored in the memory subsystem 1606, a machine readable and removable memory subsystem 1618 (e.g., flash drive form factor technology), and/or the storage subsystem(s) 1614 (e.g., optical, magnetic, solid state), including an operating system 1620, one or more application programs 1622, other program modules 1624, and program data 1626.

The operating system 1620, one or more application programs 1622, other program modules 1624, and/or program data 1626 can include items and components of the system 100 of FIG. 1, items and components of the system 200 of FIG. 2, items and flow of the diagram 300 of FIG. 3, the methods represented by the flowcharts of FIGS. 4 and 5, and the interfaces 600-1500 of the corresponding FIGS. 6-15, for example.

Generally, programs include routines, methods, data structures, other software components, etc., that perform particular tasks, functions, or implement particular abstract data types. All or portions of the operating system 1620, applications 1622, modules 1624, and/or data 1626 can also be cached in memory such as the volatile memory 1610 and/or non-volatile memory, for example. It is to be appreciated that the disclosed architecture can be implemented with various commercially available operating systems or combinations of operating systems (e.g., as virtual machines).

The storage subsystem(s) 1614 and memory subsystems (1606 and 1618) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1602, and include volatile and non-volatile internal and/or external media that is removable and/or non-removable. For the computer 1602, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1602, programs, and data using external user input devices 1628 such as a keyboard and a mouse, as well as by voice commands facilitated by speech recognition. Other external user input devices 1628 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 1602, programs, and data using onboard user input devices 1630 such a touchpad, microphone, keyboard, etc., where the computer 1602 is a portable computer, for example.

These and other input devices are connected to the microprocessing unit(s) 1604 through input/output (I/O) device interface(s) 1632 via the system bus 1608, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1632 also facilitate the use of output peripherals 1634 such as printers, audio devices, camera devices, and so on, such as a sound card and/or onboard audio processing capability.

One or more graphics interface(s) 1636 (also commonly referred to as a graphics processing unit (GPU)) provide graphics and video signals between the computer 1602 and external display(s) 1638 (e.g., LCD, plasma) and/or onboard displays 1640 (e.g., for portable computer). The graphics interface(s) 1636 can also be manufactured as part of the computer system board.

The computer 1602 can operate in a networked environment (e.g., IP-based) using logical connections via a wired/wireless communications subsystem 1642 to one or more networks and/or other computers. The other computers can include workstations, servers, routers, personal computers, microprocessor-based entertainment appliances, peer devices or other common network nodes, and typically include many or all of the elements described relative to the computer 1602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1602 connects to the network via a wired/wireless communication subsystem 1642 (e.g., a network interface adapter, onboard transceiver subsystem, etc.) to communicate with wired/wireless networks, wired/wireless printers, wired/wireless input devices 1644, and so on. The computer 1602 can include a modem or other means for establishing communications over the network. In a networked environment, programs and data relative to the computer 1602 can be stored in the remote memory/storage device, as is associated with a distributed system. It will be appreciated that the network connections shown are exemplary and other means of establishing a communications link between the computers can be used.

The computer 1602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a suggestions component configured to return local intent suggestions for a query based in part on absence of previous queries related to the query;
a merge component configured to combine the local intent suggestions and web-based suggestions for presentation as completion suggestions for the query; and
at least one microprocessor configured to execute computer-executable instructions in a memory associated with the suggestions component and the merge component.

2. The system of claim 1, further comprising a presentation component configured to visually differentiate the local intent suggestions from the web-based suggestions as auto-suggestions to the query in a user interface.

3. The system of claim 1, wherein the suggestions component processes user spatial information to derive the local intent suggestions, the spatial information based on local intent grammars and a local entity spatial index.

4. The system of claim 1, wherein the web-based suggestions are presented as combined with the local intent suggestions in a full-page view of auto-suggestions or a sub-pane of auto-suggestions that complete the query.

5. The system of claim 1, wherein the local intent suggestions relate to properties of at least one of what, where, or category.

6. The system of claim 1, further comprising a classifier component configured to generate a classifier score that corresponds to potential local intent for the query.

7. The system of claim 6, wherein the web-based suggestions are presented under, above, or with the local intent suggestions based on the classifier score.

8. The system of claim 1, further comprising a ranker component configured to order the local intent suggestions and the web-based suggestions based on query-entity features and user features.

9. A method, comprising acts of:
receiving a query as part of a search;
processing the query to return local intent suggestions based on absence of previously-logged queries and web suggestions based on previously-logged queries; and
employing the local intent suggestions as completion suggestions for the query.

10. The method of claim 9, further comprising merging and ranking the local intent suggestions and the web suggestions for presentation.

11. The method of claim 9, further comprising presenting the web-based suggestions under, above, or with the local intent suggestions based on a classifier score.

12. The method of claim 9, further comprising visually differentiating the local suggestions from the web suggestions in a user interface.

13. The method of claim 9, further comprising applying a classifier to the query to compute local intent based on dynamic and static features.

14. The method of claim 9, further comprising interpreting the query to compute top semantic interpretations.

15. The method of claim 9, further comprising deriving the local intent suggestions based on a local intent grammar and a local entity index.

16. A computer-readable storage medium comprising computer-executable instructions that when executed by a microprocessor, cause the microprocessor to perform acts of:
receiving a query as part of a search;
processing the query to return local intent suggestions based in part on absence of previously-processed queries related to the query;
merging the local intent suggestions with web suggestions;
ranking the local intent suggestions with web suggestions; and
presenting the local intent suggestions and the web suggestions as completion suggestions for the query.

17. The computer-readable storage medium of claim 16, further comprising visually differentiating the local suggestions from the web suggestions in a user interface.

18. The computer-readable storage medium of claim 16, further comprising deriving the local suggestions based on a local intent grammar and a local entity index.

19. The computer-readable storage medium of claim 16, further comprising applying a classifier to the query to compute local intent based on dynamic and static features.

20. The computer-readable storage medium of claim 16, further comprising obtaining and processing user spatial information to derive the local intent suggestions, the spatial information based on local intent grammars and a local entity spatial index.
